(19) United States
(12) Patent Application Publication
(10) Pub. No.: US 2013/0068371 A1
(43) Pub. Date: Mar. 21, 2013

(54) METHOD FOR MANUFACTURING FUEL CELL MEMBRANE-ELECTRODE ASSEMBLY ULTRASONIC VIBRATION BONDING

(71) Applicant: Hoon Hui Lee, Seoul (KR)

(72) Inventor: Hoon Hui Lee, Seoul (KR)

(73) Assignees: KIA MOTORS CORPORATION, Seoul (KR); HYUNDAI MOTOR COMPANY, Seoul (KR)

(21) Appl. No.: 13/312,378

(22) Filed: Dec. 6, 2011

(30) Foreign Application Priority Data
Sep. 21, 2011 (KR) 10-2011-0095010

(51) Int. Cl. B32B 38/08

(52) U.S. Cl. 156/73.1

(57) ABSTRACT

The present invention provides a method for manufacturing a fuel cell membrane-electrode assembly by ultrasonic vibration bonding, which prevents damage to the membrane-electrode assembly by an ultrasonic vibration horn. That is, the present invention provides a method for manufacturing a fuel cell membrane-electrode assembly in such a manner that a sub-gasket is bonded to both sides of a polymer electrolyte membrane using ultrasonic vibration and, subsequently, an electrode is coated and dried on both sides of the polymer electrolyte membrane which exposed through an opening of the sub-gasket, thereby preventing the membrane-electrode assembly from being damaged.

### CROSS-REFERENCE TO RELATED APPLICATION

This application claims under 35 U.S.C. §119(a) the benefit of Korean Patent Application No. 10-2011-0095010 filed Sep. 21, 2011, the entire contents of which are incorporated herein by reference.

### BACKGROUND

(a) Technical Field

The present invention relates to a method for manufacturing a fuel cell membrane-electrode assembly. More particularly, it relates to a method for manufacturing a fuel cell membrane-electrode assembly by ultrasonic vibration bonding, which can prevent the membrane-electrode assembly from being damaged by an ultrasonic vibration horn.

(b) Background Art

As shown in FIG. 3, a membrane-electrode assembly (MEA), which is a major component of a fuel cell stack, can be provided as a 3-layer MEA, a 5-layer MEA, and a 7-layer MEA. As shown, the 3-layer MEA 10 includes a polymer electrolyte membrane 12 and fuel and air electrodes 14, each including a catalyst and connected to both sides of the polymer electrolyte membrane 12. The 5-layer MEA includes the 3-layer MEA and further includes a sub-gasket 16, which includes an opening having an area smaller than that of each electrode 14, which is connected to the edges of the MEA 10 on both sides to facilitate the handling of the MEA 10 and improve its physical durability. The 7-layer MEA includes the 5-layer MEA and further includes a gas diffusion layer (GDL) 18, which is stacked on both outer sides of each electrode 14 including a catalyst.

When a separating plate including flow fields for supplying fuel and discharging water produced during reaction is stacked on the outer sides of the GDL 18 of the 7-layer MEA, a unit cell is formed. A fuel cell stack having a desired power output is then manufactured by stacking a plurality of such unit cells.

Here, during the manufacturing the MEA 10, the sub-gasket 16 is bonded to the MEA 10 using a hot press or roller.

That is, when the sub-gasket 16 is stacked on both sides of the 3-layer MEA and the resulting MEA is fed into the hot press or roller, the sub-gasket 16 is pressed and bonded to both sides of the 3-layer MEA 10 by a pair of rollers.

However, this process of bonding the sub-gasket 16 using a hot press or roller is problematic due to the associated long manufacturing time.

To address this problem, the present applicant provided a continuous sub-gasket bonding apparatus for manufacturing a fuel cell membrane-electrode assembly (Korean Patent Application No. 10-2011-0079414 filed on Aug. 10, 2011). This bonding process is performed while an ultrasonic vibration horn maintains a constant pressure on a support, and thus when the membrane-electrode assembly passes between the horn and the support, the membrane-electrode assembly may be damaged by the ultrasonic vibration horn.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a method for manufacturing a fuel cell membrane-electrode assembly using ultrasonic vibration, which is capable of preventing the membrane-electrode assembly from being damaged. In particular, the present invention provides a method for manufacturing a fuel cell membrane-electrode assembly in such a manner that a sub-gasket is bonded to both sides of a polymer electrolyte membrane using ultrasonic vibration, followed by coating and drying an electrode on both sides of the polymer electrolyte membrane which is exposed through an opening of the sub-gasket.

In one aspect, the present invention provides a method for manufacturing a fuel cell membrane-electrode assembly by ultrasonic vibration bonding, the method comprising: feeding a polymer electrolyte membrane and sub-gaskets into an ultrasonic vibration applying device; bonding the sub-gaskets to edges of both sides of the polymer electrolyte membrane by ultrasonic vibration; after bonding of the sub-gaskets, coating an electrode slurry on both sides of the polymer electrolyte membrane by spray coating; and drying the coated electrode slurry.

In an exemplary embodiment, after bonding of the sub-gaskets, the edges of both sides of the polymer electrolyte membrane are fixed by the sub-gaskets. As such, the electrode slurry is directly coated on both sides of the polymer electrolyte membrane.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing a method for manufacturing a fuel cell membrane-electrode assembly by ultrasonic vibration bonding in accordance with an exemplary embodiment of the present invention;

FIG. 2 is a schematic diagram showing a conventional method for manufacturing a fuel cell membrane-electrode assembly by ultrasonic vibration bonding; and

FIG. 3 is a schematic diagram showing a conventional process for manufacturing a fuel cell membrane-electrode assembly.

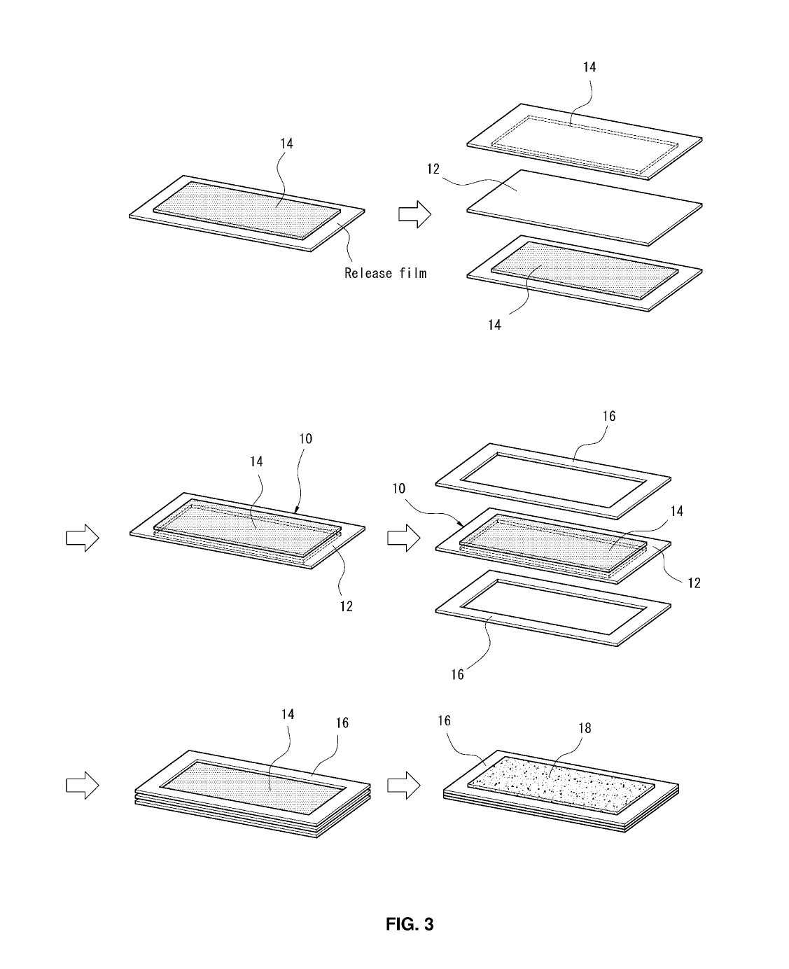

Reference numerals set forth in the Drawings includes reference to the following elements as further discussed below:

| | |
|---|---|
| 10: membrane-electrode assembly | 12: polymer electrolyte membrane |
| 14: electrode | 16: sub-gasket |
| 18: gas diffusion layer | 20: 3-layer MEA supply roll |
| 22: sub-gasket supply roll | 24: alignment device |
| 26: support roll | 30: ultrasonic vibration applying |
| | device |

40: polymer electrolyte membrane supply roll

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

First, to facilitate understanding of the present invention, a conventional method for bonding a sub-gasket to both sides of a 3-layer membrane-electrode assembly (MEA) using ultrasonic vibration will be described below.

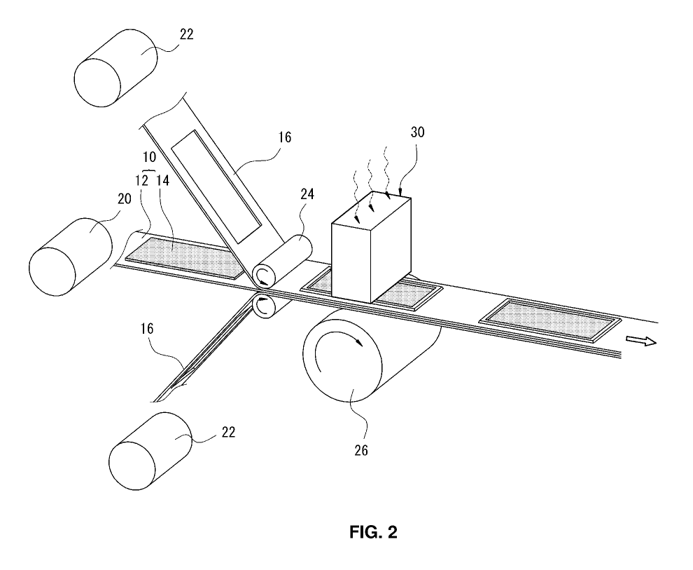

As shown in FIG. 2, a 3-layer MEA supply roll 20, which is a supply unit for bonding a sub-gasket 16 to a 3-layer MEA 10, is disposed on one side of a sub-gasket bonding apparatus, a pair of sub-gasket supply rolls 22 are disposed at the top and bottom of the 3-layer MEA supply roll 20, and an ultrasonic vibration applying device 30 for bonding the sub-gaskets 16 to the 3-layer MEA 10 is disposed on the other side.

The 3-layer MEA supply roll 20 is formed by winding the 3-layer MEA 10, which includes a polymer electrolyte membrane 12 coated on both sides with catalytic fuel and air electrode layers 14. The sub-gasket supply roll 22 is formed by winding the sub-gasket 16, which is to be subsequently bonded to upper and lower sides of four edges of the 3-layer MEA 10 as well as the edges of the electrode layers 14. Accordingly, the 3-layer MEA 10 from the 3-layer MEA supply roll 20 and the sub-gaskets 16 from the sub-gasket supply rolls 22 are fed into an alignment device 24, which is a type of preliminary bonding roller.

In particular, the 3-layer MEA 10 from the 3-layer MEA supply roll 20 is fed into the alignment device 24 and, at the same time, the sub-gaskets 16 with an adhesive coated on their inner sides are fed into the alignment device from the sub-gasket supply rolls 22. The 3-layer MEA 10 and the sub-gaskets 16 pass through the alignment device 24 and, as a result, the sub-gaskets 16 are aligned on the outer edges of the upper and lower (“outer”) sides of the 3-layer MEA 10.

After passing through the alignment device 24, the sub-gaskets 16 with the 3-layer MEA 10 interposed therebetween then pass through the ultrasonic vibration applying device 30.

The ultrasonic vibration applying device 30 applies ultrasonic vibration to the sub-gaskets 16 such that the adhesive coated on the sub-gaskets 16 is heated and cured. As a result, the sub-gaskets 16 are bonded to the edges of the polymer electrolyte membrane 12 and to the electrodes 14 by the ultrasonic vibration.

As shown in FIG. 2, a support roll 26 for supporting the sub-gasket 16 and the 3-layer MEA 10 is disposed at the bottom of the ultrasonic vibration applying device 30. The support roll 26 applies an appropriate support pressure to the 3-layer MEA 10 to assist the bonding of the sub-gasket 16 during ultrasonic vibration.

However, according to the above-described conventional method for bonding the sub-gasket to the 3-layer MEA, the bonding process is performed while an ultrasonic vibration horn (not shown) of the ultrasonic vibration applying device 30 applies a predetermined pressure to the support roll 26 with the membrane-electrode assembly 10 interposed therebetween. As such, when the membrane-electrode assembly 10 passes between the ultrasonic vibration horn and the support roll 26, the membrane-electrode assembly 10 may be damaged by the ultrasonic vibration horn.

Therefore, the present invention aims at providing a method for manufacturing a fuel cell membrane-electrode assembly in such a manner that damage to the membrane-electrode assembly is prevented. In particular, the present invention provides a method wherein a sub-gasket 16 is bonded to both sides of a polymer electrolyte membrane 12 using ultrasonic vibration. After bonding the sub-gasket 16 to the polymer electrolyte membrane 12, electrode layers 14 are then coated and dried on both sides of the polymer electrolyte membrane 12 which is exposed through an opening of the sub-gasket.

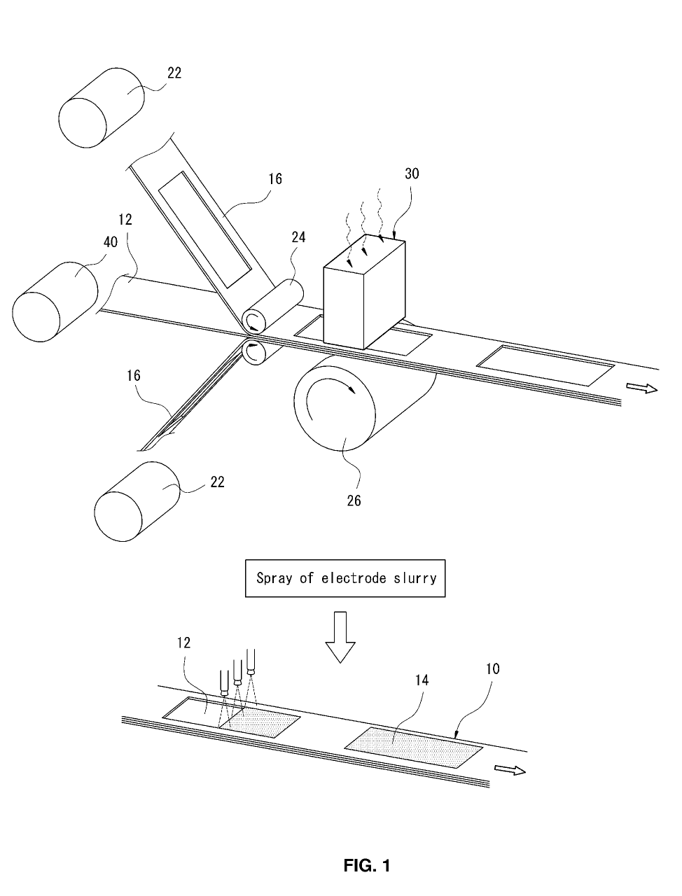

To this end, according to embodiments of the present invention as shown in FIG. 1, instead of a supply roll for supplying a 3-layer MEA (the 3-layer MEA including a polymer electrolyte membrane and an electrode coated on both sides of the polymer electrolyte membrane), a polymer electrolyte membrane (PEM) supply roll 40 is provided for supplying a polymer electrolyte membrane 12 without an electrode coated on either side. As shown, a pair of sub-gasket supply rolls 22 are further disposed above and below the polymer electrolyte membrane 12, and an ultrasonic vibration applying device 30 for bonding the sub-gasket 16 to the polymer electrolyte membrane 12 is further provided.

According to embodiments of the present invention, the PEM supply roll 40 is formed by winding the polymer electrolyte membrane 12, without a coated electrode on either side thereof. The sub-gasket supply roll 22 is formed by winding a sub-gasket 16, having an opening in the middle, which is to be subsequently bonded to upper and lower sides of four edges of the polymer electrolyte membrane 12.

Accordingly, the polymer electrolyte membrane 12 from the PEM supply roll 40 and the sub-gaskets 16 from the sub-gasket supply rolls 22 are fed into an alignment device 24.

That is, the polymer electrolyte membrane 12 from the PEM supply roll 40 is fed into the alignment device 24 and, at the same time, the sub-gaskets 16 with an adhesive coated on the inner side are fed into the alignment device from the sub-gasket supply rolls 22. The polymer electrolyte membrane 12 and the sub-gaskets 16 pass through the alignment device 24 and, as a result, the sub-gaskets 16 are aligned on the edges of the upper and lower (“outer”) sides of the polymer electrolyte membrane 12.

As such, the sub-gaskets 16 with the polymer electrolyte membrane 12 interposed therebetween pass through the alignment device 24, and then pass through the ultrasonic vibration applying device 30.

Subsequently, the ultrasonic vibration applying device 30 applies ultrasonic vibration to the sub-gaskets 16 such that the adhesive coated on the sub-gaskets 16 is heated and cured. As a result, the sub-gaskets 16 are precisely bonded to the edges of the polymer electrolyte membrane 12 by the ultrasonic vibration.

After the sub-gaskets 16 are bonded to the polymer electrolyte membrane 12 through ultrasonic vibration, both sides of the polymer electrolyte membrane 12 are exposed through the openings of the sub-gaskets 16.

After the sub-gaskets 16 are bonded to the polymer electrolyte membrane 12 through ultrasonic vibration, an electrode slurry for fuel and air electrodes can be directly coated on both sides of the polymer electrolyte membrane which are exposed through the openings of the sub-gaskets 16. Any conventional coating methods and electrode slurries could be suitably used. As a result, the electrode layers 14 thus formed are not exposed to the ultrasonic vibration, thereby preventing damage to the electrode layers 14 due to the ultrasonic vibration.

According to embodiments of the present invention, after bonding the sub-gaskets 16, the edges of both sides of the polymer electrolyte membrane 12 are physically fixed by the sub-gaskets. As such, it is further possible to prevent swelling, which may cause an undesirable change in dimensions of the polymer electrolyte membrane 12. Thus, the present methods further make it possible to accurately and uniformly coat the electrode slurry on both sides of the polymer electrolyte membrane 12 which are physically fixed.

After application of the electrode slurry, the electrode slurry coated on both sides of the polymer electrolyte membrane is dried, and the sub-gaskets 16 are bonded to the edges of both sides of the polymer electrolyte membrane 12, to thereby form a 5-layer membrane-electrode assembly which includes the electrode layers 14 formed on the inner sides thereof.

As described above, the present invention provides the following effects.

Since the fuel cell membrane-electrode assembly is manufactured in such a manner that the sub-gasket 16 is bonded to both sides of the polymer electrolyte membrane 12 using ultrasonic vibration, and subsequently, the electrode layers are coated and dried on both sides of the polymer electrolyte membrane 12 which are exposed through the opening of the sub-gasket, it is possible to prevent the membrane-electrode assembly from being damaged by the ultrasonic vibration.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for manufacturing a fuel cell membrane-electrode assembly by ultrasonic vibration bonding, the method comprising:
feeding a polymer electrolyte membrane and sub-gaskets into an ultrasonic vibration applying device;
bonding the sub-gaskets to edges of both sides of the polymer electrolyte membrane by ultrasonic vibration;
coating an electrode slurry on both sides of the polymer electrolyte membrane; and
drying the coated electrode slurry.

2. The method of claim 1, wherein after bonding the sub-gaskets, the edges of both sides of the polymer electrolyte membrane are fixed by the sub-gaskets, and the electrode slurry is directly coated on both sides of the polymer electrolyte membrane.

3. The method of claim 1, wherein the step of coating an electrode slurry on both sides of the polymer electrolyte membrane comprises spray coating.

4. The method of claim 1, wherein the step of feeding the polymer electrolyte membrane and sub-gaskets into an ultrasonic vibration applying device comprises feeding a stacked layer comprising the polymer electrolyte membrane with the sub-gaskets stacked on both sides of the polymer electrolyte membrane.

5. The method of claim 1 further comprising, prior to feeding the polymer electrolyte membrane and sub-gaskets into the ultrasonic vibration applying device, feeding the polymer electrolyte membrane and sub-gaskets into an alignment device.

6. The method of claim 1, wherein the sub-gaskets each having an opening in a central portion exposing the polymer electrolyte membrane, and wherein coating the electrode slurry on both sides of the polymer electrolyte membrane comprises coating the exposed polymer electrolyte membrane on both sides.
